(19) United States
(12) Patent Application Publication
(10) Pub. No.: US 2016/0155253 A1
(43) Pub. Date: Jun. 2, 2016

(54) ELECTRONIC DEVICE AND METHOD OF DISPLAYING IMAGES ON ELECTRONIC DEVICE

(71) Applicants: Inventec (Pudong) Technology Corporation, Shanghai (CN); INVENTEC CORPORATION, Taipei (TW)

(72) Inventor: Sheng-Hsin Lo, Taipei (TW)

(21) Appl. No.: 14/686,153

(22) Filed: Apr. 14, 2015

(30) Foreign Application Priority Data
Nov. 27, 2014 (CN) 201410710617.2

(51) Int. Cl. G06T 11/60; G06T 17/05; G06T 7/00

(52) U.S. Cl. CPC G06T 11/60; G06T 7/004; G06T 17/05

(57) ABSTRACT

An electric device and a method of displaying images on the electric device are provided. The electronic device includes a communication unit, an information acquirement unit, and a processing unit. The communication unit receives a target image with a position information and an orientation information. The information acquirement unit acquires the position information and the orientation information. The processing unit acquires a first street view corresponding to the position information and combines the target image with the first street view to generate a second street view according to the orientation information.

### CROSS-REFERENCE TO RELATED APPLICATIONS

This non-provisional application claims priority under 35 U.S.C. §119(a) on Patent Application No(s). 201410710617.2 filed in China on Nov. 27, 2014, the entire contents of which are hereby incorporated by reference.

### BACKGROUND OF THE INVENTION

1. Technical Field of the Invention

The disclosure relates to an image processing device and an image processing method, more particularly to a street view technology-based electronic device and a method of displaying images on an electronic device.

2. Description of the Related Art

With the development of technology, various electronic devices can provide users various services, especially a positioning system such as the very popular Google maps.

Google maps lets a user input an address to search for a destination and then replies to the user with a customized link to a parameterized split street or map view (referred to as the link of map hereinafter) according to the search result. Such a link of map provided by Google maps is a specific character string (e.g. http://goo.glimaps/krQQU) or is a character string with the longitude and latitude information of the destination (e.g. http://maps.google.com/?q=25.085819,121.5224002), so that each link of map corresponds to a specific longitude and a specific latitude.

Sometimes people would like to share a link of map with one another to let him or her know the longitude and latitude information of a destination. For example, a user can send a link of map to a friend getting lost to this friend to find the way to a restaurant where the user is. Each link of map usually corresponds to a street view that is a 360-degree panorama of stitched images. If this receiver receiving the link of map is not familiar with the ambient geographic environment of the restaurant, the receiver may not be able to get help. On the other hand, since the street view is not uploaded in real time, something that is nonexistent now may appear in the street view and make the receiver confused.

### SUMMARY OF THE INVENTION

According to one or more embodiments, the disclosure provides a method of displaying images on an electronic device including a communication unit, an information acquirement unit, and a processing unit. In one embodiment, the method includes the following steps. By the communication unit, acquire a target image with position information and orientation information. By the information acquirement unit, acquire the position information and the orientation information. By the processing unit, acquire a first street view corresponding to the position information. According to the orientation information, combine the target image with the first street view to generate a second street view.

In other one embodiment, when the target image is combined with the first street view, a correspondent region on the first street view corresponding to the target image is searched for according to the orientation information, and the target image is superimposed on the correspondent region on the first street view to generate the second street view.

In other one embodiment, the correspondent region on the first street view corresponds to a capturing range related to the target image.

In other one embodiment, the position information includes a longitude value and a latitude value.

In other one embodiment, the target image further has elevation angle information, and the processing unit searches for a correspondent region on the first street view corresponding to the target image according to the orientation information and the elevation angle information.

In other one embodiment, the first street view is stored in a remote server.

According to one or more embodiments, the disclosure provides an electronic device. In one embodiment, the electronic device includes a communication unit, an information acquirement unit, and a processing unit. The communication unit receives a target image with position information and orientation information. The information acquirement unit is coupled with the communication unit to acquire the position information and orientation information of the target image. The processing unit is coupled with the communication unit and the information acquirement unit to acquire a first street view corresponding to the position information and combine the target image with the first street view according to the orientation information to generate a second street view.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a schematic diagram of interaction between two electronic devices according to an embodiment of the disclosure;

FIG. 2 is a schematic view of a target image captured by the electronic device in

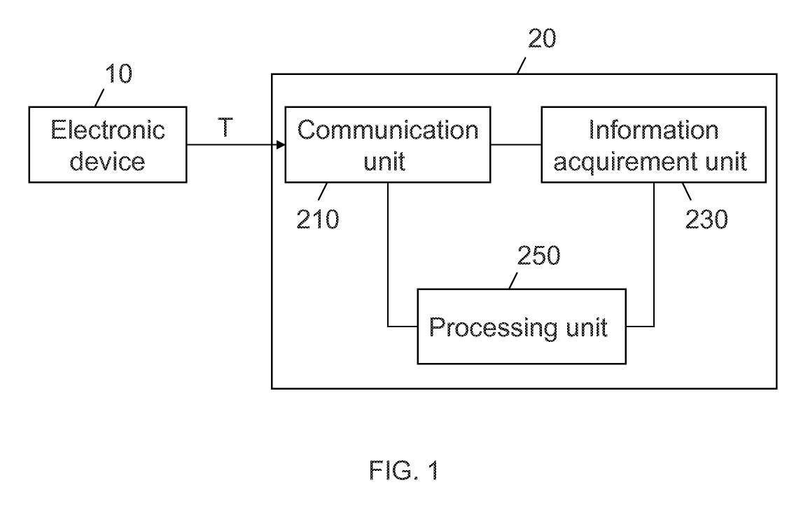

FIG. 1 according to an embodiment of the disclosure;

FIG. 3 is a schematic view of a relation between a portion of a first street view and its map according to an embodiment of the disclosure;

FIG. 4 is a schematic view of a relation between a portion of a second street view and its map according to an embodiment of the disclosure; and

FIG. 5 is a flow chart of a method of displaying images on an electronic device according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

FIG. 1 is a schematic diagram of interaction between two electronic devices according to an embodiment of the disclosure. In the drawing, an electronic device 10 can send data to another electronic device 20. The electronic device 10 has image capturing, communication and positioning functions, but the disclosure will not be limited thereto. The electronic device 20 includes a communication unit 210, an information acquirement unit 230, and a processing unit 250. The information acquirement unit 230 is coupled with the communication unit 210. The processing unit 250 is coupled with the communication unit 210 and the information acquirement unit 230.

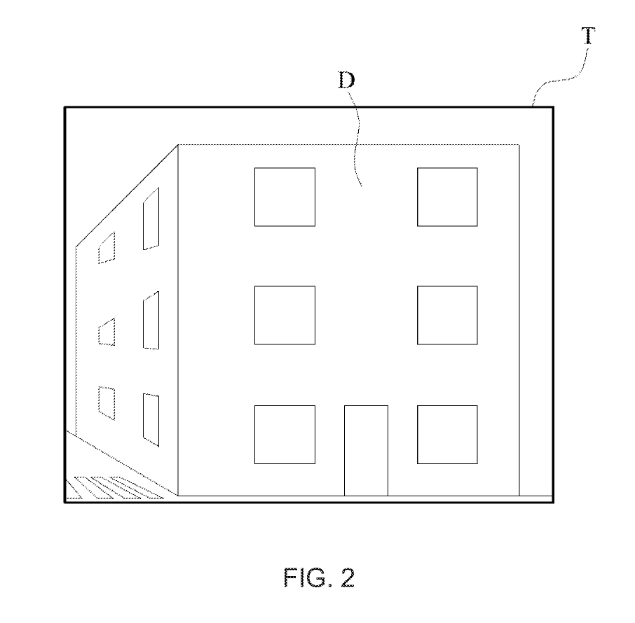

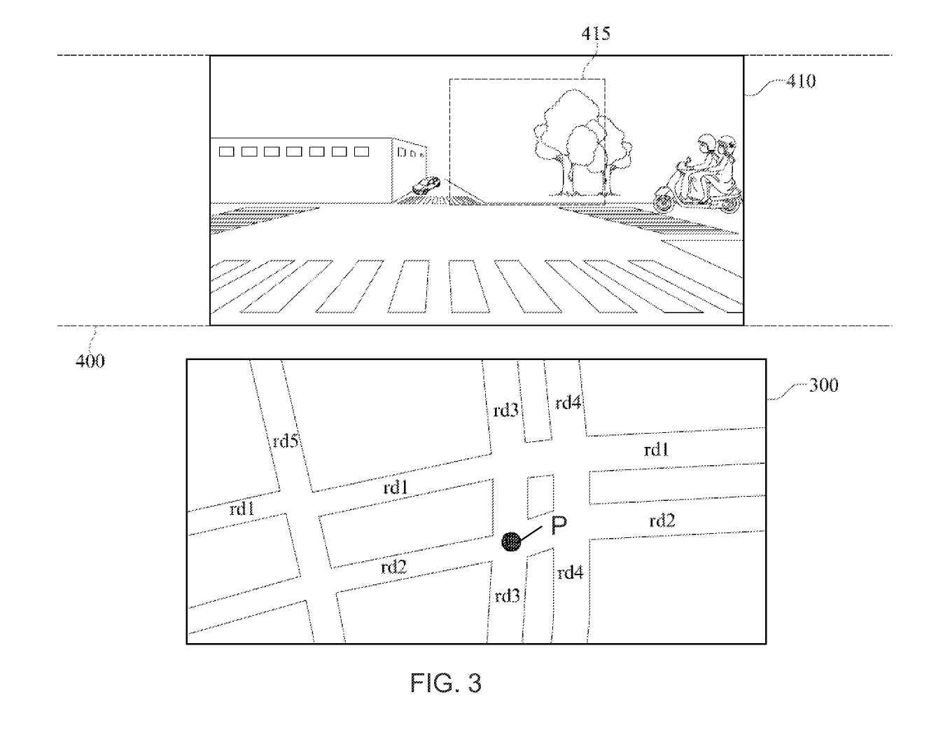

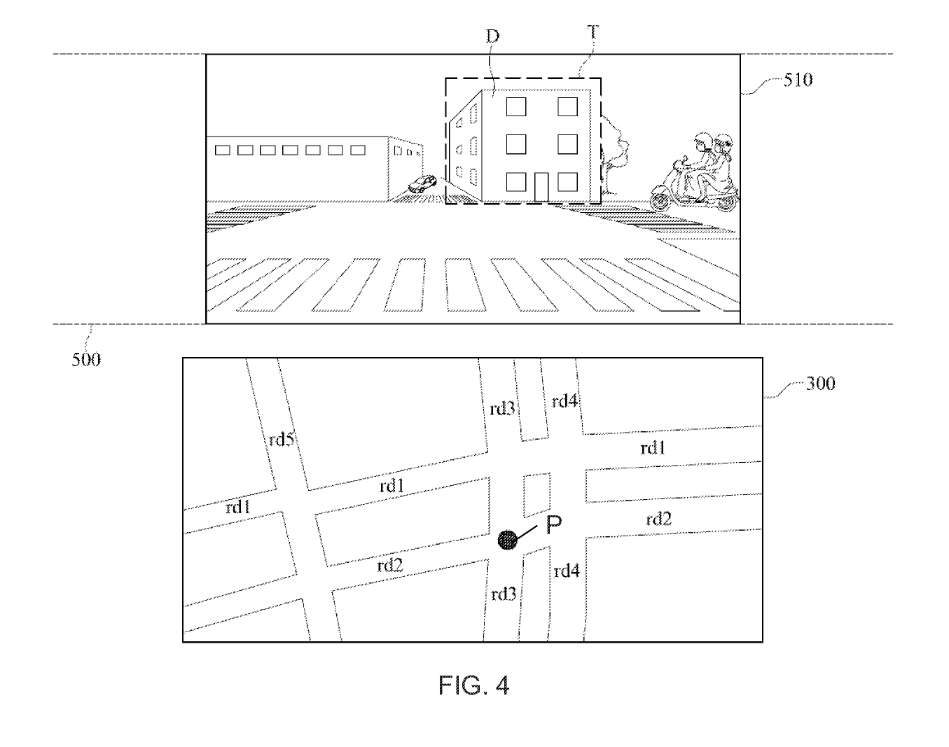

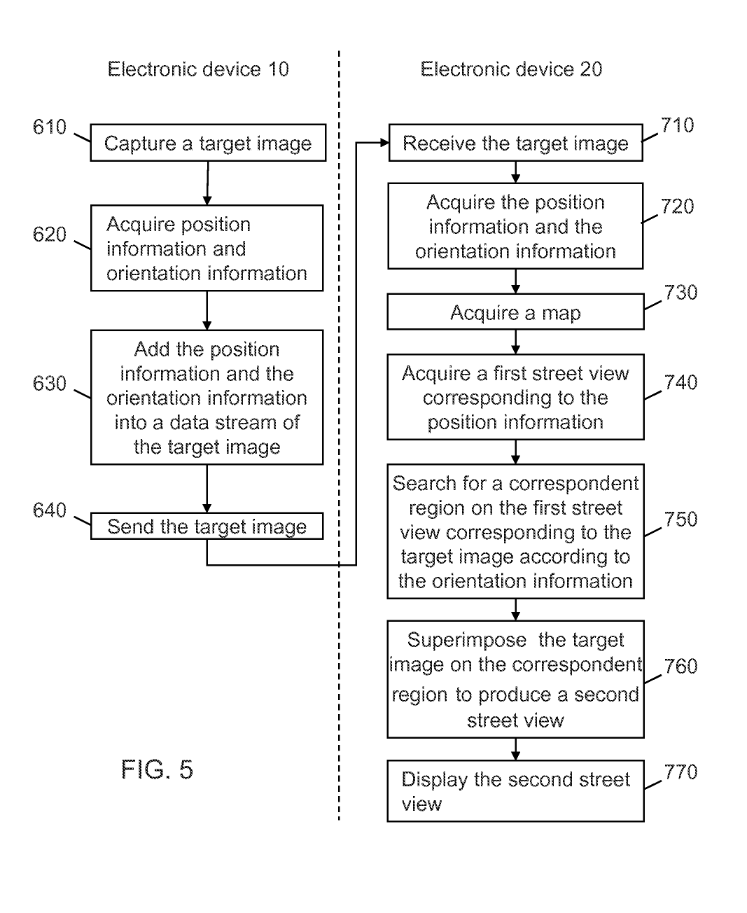

When a user A of the electronic device 10 attempts to send relative information about a landmark D such as a building to a user B of the electronic device 20, the user A uses the electronic device 10 to capture a target image T capturing an image of the landmark D, as shown in FIG. 2. Then, the electronic device 10 can acquire the position information and orientation information about its location. In this embodiment, the position information includes a longitude value and a latitude value, and the orientation information is an orientation that the electronic device 10 faces to when capturing the target image T. In this or some embodiments, the electronic device 10 further includes a positioning module (e.g. GPS) for providing the position information, and an electronic compass for providing the orientation information. Subsequently, the electronic device 10 adds the position information and the orientation information to a data stream of the target image T and sends the data stream of the target image T to the electronic device 20 by any possible communication way. The detailed operation of the internal units in the electronic device 20 is described below.

The communication unit 210 transmits or receives data by a wireless communication manner such as the Global System for Mobile Communications, Wi-Fi, Bluetooth, or NFC technology, or a wired communication manner such as Ethernet. For example, the communication unit 210 is embodied by a microprocessor or any possible function chip, but the disclosure will not be limited thereto. The communication unit 210 receives the target image T with the position information and the orientation information. In practice, the data received by the communication unit 210 is a picture or a video. If the communication unit 210 receives a picture, this picture is considered as the target image T and transmitted to the information acquirement unit 230. If the data received by the communication unit 210 is a video which records images of parts of a building captured from bottom to top in an example, this video is sent from the communication unit 210 to the processing unit 250 and is divided into multiple frame images by the processing unit 250. The processing unit 250 further combines some or whole of these frame images by a specific algorithm to generate a larger image considered as the target image T which a complex building is presented within, and sends this larger image to the information acquirement unit 230 through the communication unit 210.

In this embodiment, the target image T has the above position information and the above orientation information. In some embodiments, the target image T further includes other information such as elevation angle information about the electronic device 10. For example, the elevation angle information about the electronic device 10 is an elevation angle that the electronic device 10 captures the target image T, a distance between the electronic device 10 and a target landmark, and/or an angle of view of the electronic device 10, but the disclosure will not be limited thereto. In an embodiment, the elevation angle information is provided by an electronic compass in the electronic device 10.

In an embodiment, since the electronic device 10 adds its position information and orientation information to the data stream of the target image T so that the information acquirement unit 230 can extract out the position information and the orientation information from the data stream of the target image T. In other one embodiment, the electronic device 10 can further add other information such as the elevation angle related to the target image T, a distance between a target landmark and the electronic device 10, and/or the angle of view of the electronic device 10 to the data stream of the target image T so that the information acquirement unit 230 can acquire such information. In other one embodiment, the electronic device 10 directly transmits the position information and orientation information or transmits the position information, orientation information, and other information to the communication unit 210 without adding them in the data stream of the target image T. For instance, the information acquirement unit 230 is embodied by a microprocessor or other function chips, but the disclosure will not be limited thereto.

The processing unit 250 can acquire a map, acquire a street view corresponding to the position information, and combine the target image T with the street view to generate a new street view according to the orientation information. For example, the processing unit 250 is embodied by a microprocessor or any suitable function chip, but the disclosure will not be limited thereto. The detailed operation of the processing unit 250 is described below.

Please refer to FIGS. 1, 3 and 4. FIG. 3 is a schematic view of a relation between a portion of a first street view and its map according to an embodiment of the disclosure, and FIG. 4 is a schematic view of a relation between a portion of a second street view and its map according to an embodiment of the disclosure. A map 300 presents roads rd1 to rd5 and a reference point P of the position information. For example, a first street view 400 in FIG. 3 and a second street view 500 in FIG. 4 are 360-degree panoramic views or fisheye views. To clearly describe the disclosure, FIG. 3 and FIG. 4 only show a portion 410 of the first street view 400 and a portion 510 of the second street view 500 respectively.

After the communication unit 210 receives the target image T with the position information and the orientation information, the information acquirement unit 230 acquires the position information, e.g. the longitude value and the latitude value, and the orientation information related to the target image T. After acquiring the map 300 corresponding to the position information, the processing unit 250 acquires the first street view 400 corresponding to the position information. The first street view 400 is stored in a remote server. Then, the target image T is combined with the first street view 400 according to the orientation information to generate the second street view 500. Therefore, the user B can visually use the second street view 500 to find out the target landmark D that the user A notifies the user B to leave for, and know the geographic relationship between the location of the user B and the target landmark D.

In the embodiment, the processing unit 150 further searches for a correspondent region 415 on the first street view 400 corresponding to the target image T according to the orientation information, as shown in FIG. 3. Specifically, since the target image may further have elevation angle information, the processing unit 150 may search for the correspondent region 415 on the first street view 400 corresponding to the target image T according to the orientation information and the elevation angle information.

Subsequently, the processing unit 150 superimposes the target image T on the correspondent region 415 on the first street view 400 to generate the second street view 500. The correspondent region 415 on the first street view 400 corresponds to a capturing range (e.g. the field of view (FOV)) related to the target image T. In other words, the correspondent region 415 on the first street view 400 is related to an elevation angle of capturing the target image T, a distance between the user A and a target landmark D, and/or an angle of view of the electronic device 10. Therefore, the correspondent region 415 and the target image T may have differences on size and shape therebetween. The processing unit 150 can use different algorithms to search for the correspondent region 415 corresponding to the target image T, but the disclosure will not be limited thereto.

Therefore, the user B can observe the relationship between the target landmark D and other ambient objects shown in the portion 510 of the second street view 500 in FIG. 4 and also shift the second street view 500 to observe the relationship between the target landmark D and ambient other objects in another portion of the second street view 500. Because the target landmark D is recorded in the target image T, the user A can easily provide the position information and orientation information of the target landmark D to the user B, and then the user B can visually observe the second street view 500 to check the relative position of the target landmark D. In this way, the street view to the user B may surely present the target landmark D.

The operation of the above electronic devices and the interaction between the above electronic devices are described as follows. Please refer to FIG. 1 to FIG. 5. FIG. 5 is a flow chart of a method of displaying images on an electronic device according to an embodiment of the disclosure. In step S610, the electronic device 10 captures a target image T. In step S620, the electronic device 10 acquires its position information (e.g. the longitude value and the latitude value) and orientation information. In step S630, the electronic device 10 adds the position information and the orientation information into a data stream of the target image T. In step S640, the electronic device 10 sends out the target image T to the electronic device 20.

In step S710, the communication unit 110 receives the target image T with the position information and the orientation information. In step S720, the information acquirement unit 130 acquires the position information and the orientation information. In step S730, the processing unit 150 acquires the map 300. In step S740, the processing unit 150 acquires the first street view 400 corresponding to the position information. In step S750, the processing unit 150 searches for the correspondent region 415 on the first street view 400 corresponding to the target image T according to the orientation information. In step S760, the processing unit 150 superimposes the target image T on the correspondent region 415 on the first street view 400 to generate the second street view 500. In step S770, the processing unit 150 makes the second street view 500 displayed. The details of steps S610 to S640 and S710 to S770 are described in the above embodiments and will not be repeated hereinafter.

In the disclosure, after the electronic device 10 of the user A captures the target image T, adds its position information and orientation information to the target image T, and sends the target image T to the electronic device 20 of the user B, the electronic device 20 searches the correspondent region 415 on the first street view 400 corresponding to the capturing range related to the target image T according to the orientation information and superimposes the target image T on the correspondent region 415 on the first street view 400 to generate the second street view 500. Therefore, the user A can easily share the position information and orientation information of the location of the user A to the user B, and then the user B can visually know the relative position of the target landmark D in the second street view 500. Moreover, the first street view 400 may surely present the landmark D.

What is claimed is:

1. A method of displaying images on an electronic device comprising a communication unit, an information acquirement unit, and a processing unit, and the method comprising:
receiving a target image with a position information and an orientation information by the communication unit;
acquiring the position information and the orientation information by the information acquirement unit;
acquiring a first street view corresponding to the position information by the processing unit; and
combining the target image with the first street view to generate a second street view according to the orientation information.

2. The method according to claim 1, wherein the step of combining the target image with the first street view to generate the second street view comprises:
searching for a correspondent region on the first street view corresponding to the target image according to the orientation information; and
superimposing the target image on the correspondent region on the first street view to produce the second street view.

3. The method according to claim 2, wherein the correspondent region corresponds to a capturing range related to the target image.

4. The method according to claim 1, wherein the position information comprises a longitude value and a latitude value.

5. The method according to claim 1, wherein the target image further has elevation angle information, and when the target image is combined with the first street view, the processing unit searches for a correspondent region on the first street view corresponding to the target image according to the orientation information and the elevation angle information.

6. The method according to claim 1, wherein the first street view is stored in a remote server.

7. An electronic device, comprising:
a communication unit for receiving a target image with a position information and an orientation information;
an information acquirement unit coupled with the communication unit, for acquiring the position information and the orientation information of the target image; and
a processing unit coupled with the communication unit and the information acquirement unit, for acquiring a first street view according to the position information and combining the target image with the first street view according to the orientation information to generate a second street view.

8. The electronic device according to claim 7, wherein the processing unit further searches for a correspondent region on the first street view corresponding to the target image according to the orientation information and superimposes the target image on the correspondent region on the first street view to generate the second street view.

9. The electronic device according to claim 8, wherein the correspondent region corresponds to a capturing range related to the target image.

10. The electronic device according to claim 7, wherein the target image further has elevation angle information, and the processing unit further searches a correspondent region on the first street view corresponding to the target image according to the orientation information and the elevation angle information.
